(19) United States
(12) Patent Application Publication
(10) Pub. No.: US 2006/0277217 A1
(43) Pub. Date: Dec. 7, 2006

(54) Method for creating a data file

(75) Inventors: Jaakko Lehikoinen, Hameenkyro (FI); Severi Uusitalo, Palkane (FI); Jussi Impio, Hameenlinna (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/143,241

(22) Filed: Jun. 1, 2005

(51) Int. Cl. G06F 17/30

(52) U.S. Cl. 707/200

(57) ABSTRACT

A function for creating a new file by editing and synthesizing one or more data files such as pictures, movies, and music, is very promising function and provides a new possibility to the portable electronic devices. However, in the existing technology, the user may be bothered with selecting items for a new data file from a lot of items stored in the portable electronic device. In this patent application, an invention that may be used for easy-selection of items in such cases will be disclosed.

### FIELD OF THE INVENTION

The present invention is related with creating a new data file from one or more items.

### BACKGROUND OF THE INVENTION

In recent years, portable electronic devices such as cell phones, PDAs, or notebook computers have been equipped with various multimedia features. For example, the portable electronic devices having a camera have already become popular in the market, and many of them can take not only still pictures but also movies. Also, some cell phones or PDAs have been equipped with a music player function, and these devices can play music files downloaded from personal computers, Internet, or network operators. Moreover, portable electronic devices with an edit-function for editing taken pictures or videos have already sold in the market. For example, Nokia6630, which is a cell phone product of the applicant, has a function to create a new video clip by editing and synthesizing text, pictures, movies, and music. The created movie file can be contributed to the user's fun, or can be sent to other person by messaging application such as MMS. See Vodafone 702NK (Nokia6630) User Guide, 1st edition (9235850), page 35 of English instruction.

Such a function, i.e. a function for creating a new file by editing and synthesizing one or more data files such as pictures, movies, and music, is very promising function and provides a new possibility to the portable electronic devices. However, in the existing technology, the user may be bothered with selecting items for a new data file from a lot of items stored in the portable electronic device. In this patent application, an invention that may be used for easy-selection of items in such cases will be disclosed.

### SUMMARY OF THE INVENTION

According to one aspect of the present invention, there is provided a portable electronic device creating a new data file being arranged:
to record an event history associated with an item accessed by the portable electronic device;
to select an item for the new data file by utilizing the event history; and
to create the new data file from the decided item.
   And according to another aspect of the present invention, there is provided a portable electronic device creating a new data file being arranged:
to record an event history associated with an item accessed by the portable electronic device;
to present the item recorded in the event history for a user to select the recorded item for the new data file; and
to create the new data file from the item selected by the user.

By virtue of said portable electronic devices, an item for creating a new data file can be decided easily by utilizing an event history associated with the item. Therefore a user can create a new data file quite easily.

According to another aspect of the present invention, there is provided a computer program for creating a new data file by a portable electronic device, wherein the computer program instructing the portable electronic device to work as:
means for recording a event history associated with an item accessed by the portable electronic device;
means for deciding an item for the new data file by utilizing the event history; and
means for creating the new data file from the decided item.

By virtue of the computer program, an item for creating a new data file can be decided easily by utilizing an event history with regard to the item. Therefore a user can create a new data file easily. The subject that decides the item could be the program or a user. In one embodiment, for example, the above-mentioned program may be arranged to operate the electronic device to select an item accessed in a predetermined period for said new data file. In another embodiment, the above-mentioned program may be arranged to operate the electronic device to select an item used in a period specified by a user. In still further embodiment, the above-mentioned program may be arranged to provide a user interface for enabling a user to select an item recorded in the access history to use it for creating the new data file.

Said item may be, for example, a text data file, an audio data file, a still image file, or a movie data file. However, the item is not limited to them. And said new data file may comprise one or more of text data, audio data, still image data, and movie data. These items or data files may be stored in memories embedded in the portable electronic device such as flash memories or in removable memories such as MMC cards, or in external storage devices connected with the portable electronic device by i.e. USB, Bluetooth, Ethernet, Cellular network, or Internet.

Preferably, the event history records, in relation to an occurrence of an event, identity information of the item associated with an event and/or a time of the event occurred. The event may contain at least one of an opening, an editing, and a transmitting of the item.

According to another aspect of the present invention, there is provided a portable electronic device comprising a computer program comprising a part or a whole of features mentioned above.

According to another aspect of the present invention, there is provided a method for creating a new data file in a portable electronic device comprising:
a step for recording an event history associated with an item accessed by the portable electronic device;
a step for selecting an item for the new data file by utilizing the event history; and
a step for creating the new data file from the decided item.

According to still further aspect of the present invention, there is provided a method for creating a new data file in a portable electronic device comprising:
a step for recording an event history associated with an item accessed by the portable electronic device;
a step for presenting the item recorded in the event history for a user to select the recorded item for the new data file; and
a step for creating the new data file from the item selected by the user.

### BRIEF DESCRIPTION OF DRAWINGS

The present invention will now be described by way of example with reference to the accompanying drawings, in which:

FIG. 1 illustrates an appearance of the imaging phone 1 introduced as an example in the preferred embodiment of the present invention.

FIG. 2 illustrates a menu screen of the imaging phone 1.

FIG. 3 is a schematic block diagram of hardware configuration of the imaging phone 1.

FIG. 4 is a schematic block diagram of software configuration of the multimedia presentation creating software 39 introduced as an example in the preferred embodiment of the present invention.

FIG. 5 is a flow chart illustrating a sequence of creating the multimedia presentation in the preferred embodiment.

FIG. 6 is a flow chart illustrating flows for deciding items used for a presentation to be created in the preferred embodiment.

FIGS. 7-10 illustrate the aspects of certain stages of multimedia presentation creating software 39.

### DETAILED DESCRIPTION OF THE INVENTION

A preferred embodiment will be explained herein below by using an example of selecting several data files of pictures, movies, or music, and creating a new data file by editing and synthesizing them. As the created data file will contain multimedia contents such as a picture, a movie, or a music, this data file will be called hereafter as a multimedia presentation (file).

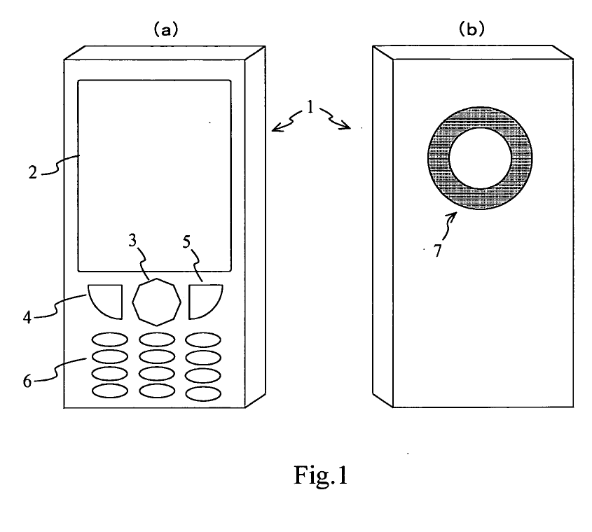

FIG. 1 shows appearance of an imaging phone according to the present invention. FIG. 1(a) shows a front view and (b) shows back view. An imaging phone 1 comprises a LCD screen 2, a function key 3, a left key 4, a right key 5, and ten-key 6 on the front side, and a camera 7 on the back side. The LCD screen 2 displays information relating to cellular phone functions such as signal condition, remaining battery, phone number. The LCD screen 2 is also used as a display for installed applications. The LCD screen 2 is also used as a monitor of the camera 7. A view of which a user is going to capture will be displayed on the LCD screen 2. The function key 3, the left key 4, and the right key 5 are used to access to various functions of the imaging phone 1. In addition, the left key 4 and the right key 5 are used for on-hook and off-hook. The ten-key 6 is used to input phone numbers and texts. Most of the keys are allocated several functions on them. The imaging phone 1 comprises not only telephony and camera functions, but also various functions i.e., a messaging function such as e-mail or MMS, and PIM functions.

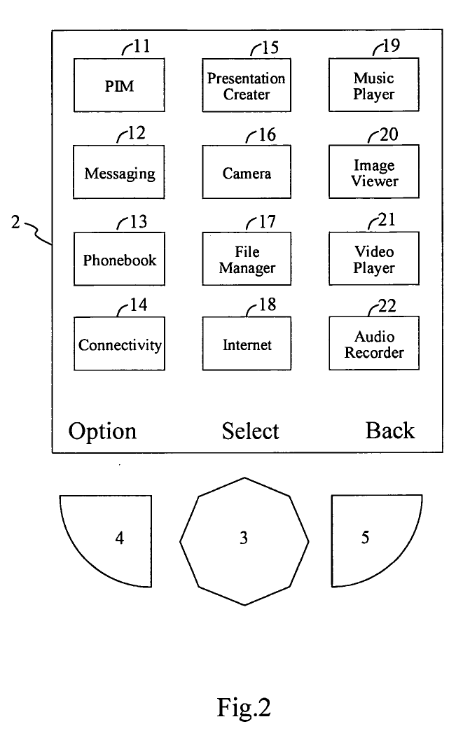

By pressing the left part of function key 3, the user can access Menu screen of the imaging phone 1. The menu screen of the imaging phone 1 is shown in FIG. 2. Icon 11-22 is displayed in the screen 2; each icon provides access to the feature of the imaging phone 1. The user can access desired functions by selecting the icons by manipulating function key 3 and pressing midsection of function key 3.

By selecting icon 11, the user can access PIM features. The PIM features include functions such as a scheduler, a task management, or a notepad. By choosing icon 12, the user can access the messaging function such as SMS, MMS, or e-mail. Icon 13 is associated with a phonebook function. Icon 14 relates to the connectivity function to the external devices. Imaging phone 1 can be connected with the external devices by using USB or wireless connections such as Bluetooth. Icon 15 is associated with the multimedia presentation creation function by the present invention. Details about the presentation creation function will be described later.

When choosing icon 16, the user can make the camera 7 active and can take a still picture or a video image. Icon 17 relates to the file management function. Through this function, the user can access, open and manage a wide range of files such as image files and video files, sound files, and text files stored in the imaging phone 1. Icon 18 is associated with the Internet access function. Icon 19 is associated with the music player feature. The user can listen to the music downloaded from personal computers or Internet with the imaging phone 1 using music player 19. Icon 20 relates to the image viewer feature and the user can see still images such as photographs taken by camera 7 or obtained from external devices through the connectivity function 14. Icon 21 relates to the video player feature and the user can see the video taken by camera 7 or obtained from external devices. Icon 22 relates to the sound recorder function. In this way, imaging phone 1 has a wide range of functions and the user can access these features from Menu screen.

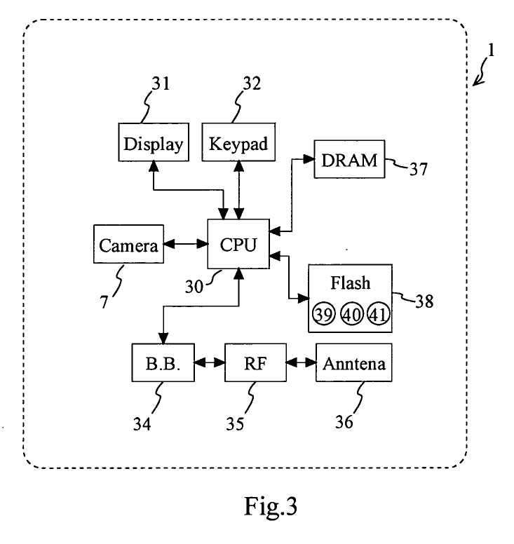

FIG. 3 is a schematic block diagram illustrating hardware configuration of imagine phone 1. The imaging phone 1 comprises a CPU 10, and CPU 10 is connected with a camera module 7, a display 31, a keypad 32, a baseband processing unit 34, a DRAM 37, a flash memory 38 and etc. The flash memory 38 stores an operating system (OS) 41 of the imaging phone 1. CPU 30 and OS 41 cooperate in each other to compose a controller for controlling operations of the imaging phone 1. The flash memory 38 also stores multimedia presentation creating software 39, a MMS software 20 taking charge of the messaging function, and a variety of application software. These software cooperate with CPU 30 and the other hardware of the imaging phone 1 to operate the imaging phone 1 as an information processing apparatus with specific functions. The display 31 comprises the LCD screen 2. Keypad 32 comprises a plurality of keys such as function key 3, left key 4, right key 5, and ten-key 6 shown in FIG. 1. The baseband processing unit 34 is connected to a RF processing unit 35 and an antenna 36. They are taking charge of functions relating to signal transmission and reception. The baseband-processing unit 34 works for digital encoding/decoding, error correction, and so on. The RF processing unit 35 works for frequency conversion to/from a carrier frequency and so on. DRAM 37 works as a main memory of the imaging phone 1. Since DRAM have a faster access speed than flash memory, frequently used data or programs will be stored in the DRAM when the imaging phone 1 is working. OS41 or other application software may also be moved (or copied) to and used from the DRAM 37 when the imaging phone 1 is working; even initially they are stored in the flash memory 38. SRAM or SDRAM may be used as a main memory.

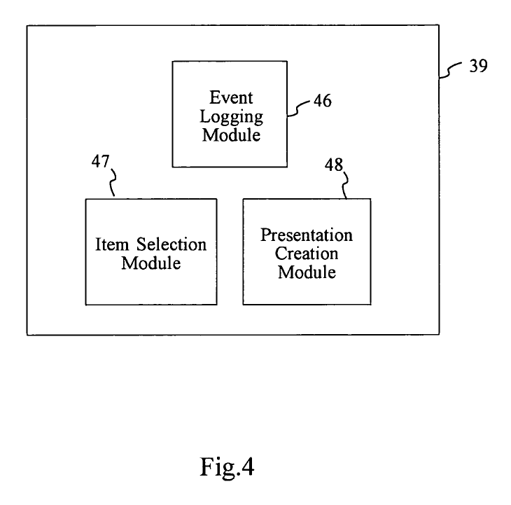

FIG. 4 is a schematic block diagram illustrating the configuration of the multimedia presentation creating software 39 according to the present invention. The presentation creating software 39 comprises 3 software modules, an event-record module 46, an item-selection module 47, and a presentation-creating module 48. When an event such as opening, editing or sending of an item in the imaging phone 1 occurs, the event-record module 46 records the event in an access history by recording the name of the item and the kind of the item together with the time of occurrence. The items herein may be, for example, data files of photographs, videos, music, or texts. However it should be noted that the item is not limited to them.

The item selection module 47 is a software module to decide the items to be used for the multimedia presentation to be created. The item selection module 47 provides three ways for item selection, the auto selection, the selection based on user-designated period, and the manual selection. Details feature of the item selection module 47 will be described later.

The presentation-creating module 48 creates a new multimedia presentation using the items that have been selected by the item selection module 47. As the items may be data files of photographs, videos, or music, the multimedia presentation to be created can also be a data file containing these multimedia contents. For example, the created multimedia presentation may be a movie file, in which the selected pictures are presented at the beginning of the movie, then the selected videos are played after the pictures, while the selected music are played as a background music. The presentation creating module 48 can automatically edit and adjust the length of the multimedia presentation to suit to the transmitting by, i.e. MMS. The created multimedia presentation can be replayed with the video player 21. In addition to this example, a lot of embodiments are possible to create various styles of data files by combining, synthesizing, or editing still images, videos, sounds, and texts.

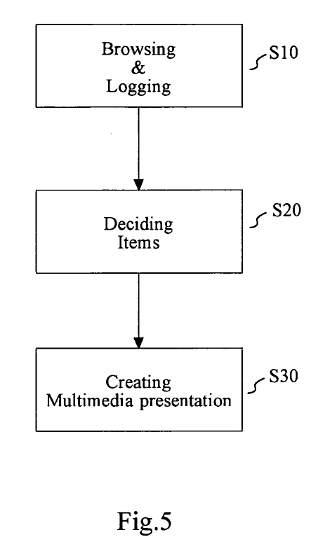

In the following, the aspect of creating a multimedia presentation by the imaging phone 1 will be described in order. FIG. 5 is a flow chart illustrating a sequence of creating the multimedia presentation in this embodiment.

In step 10, the user accesses various items, and such events are recorded in the access history by the event record module 46. In this step, the user may listen to the music file downloaded from the PC or Internet with the music player 19, watch pictures or videos taken by the camera module 7, or send a data file such as a sound, an image, a movie or a text as an attachment of MMS. The event record module 46 records the time that the user accessed to these files in the access record together with names of these files and the file types (image, video, audio, or so). In another embodiment, the event record module 46 may be arranged to record the kind of events together with them.

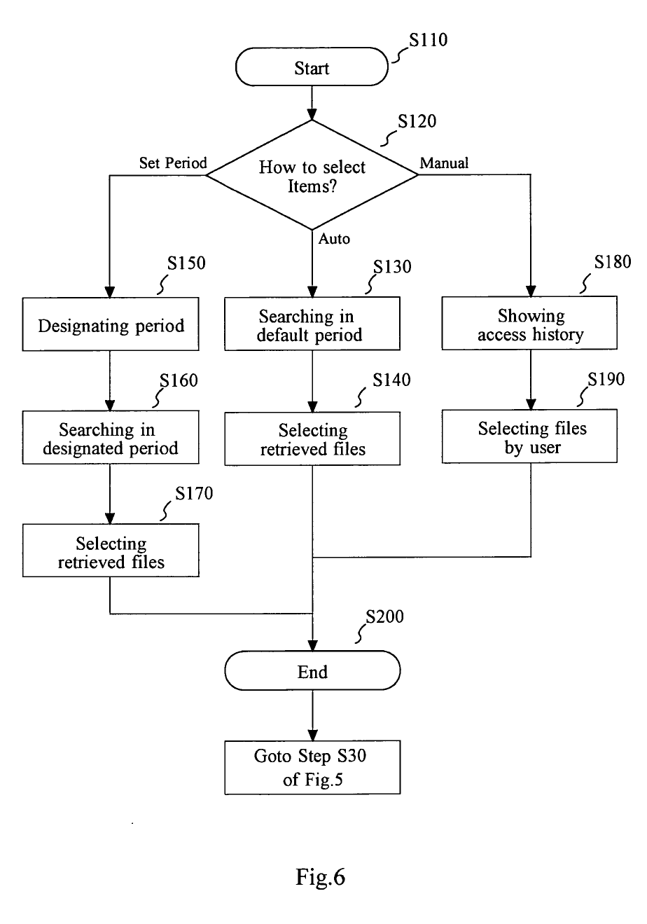

Step 20 is the step in which the items to be used for the new presentation file are decided by the item selection module 47. This step will be described below in detail using FIG. 6.

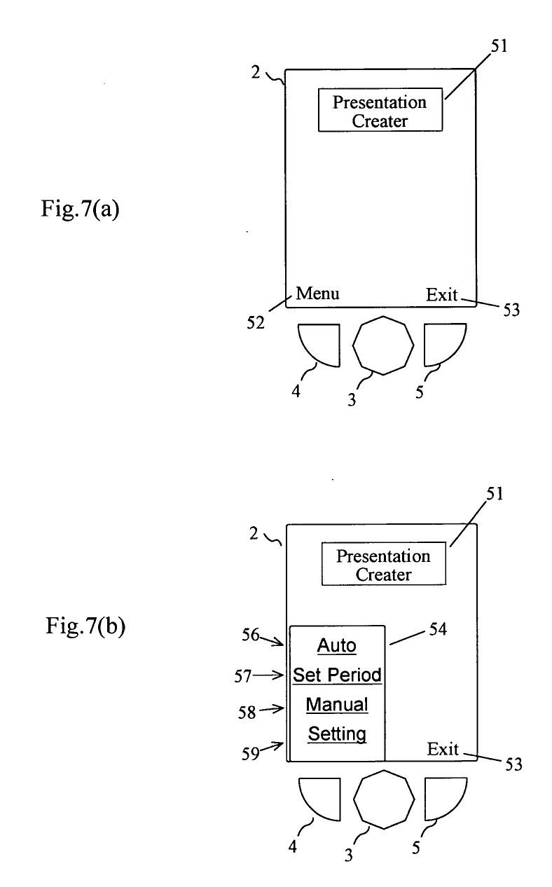

FIG. 6 is a flow chart illustrating flows for deciding items used for a presentation to be created. At first, the item selection module 47 is started up in step S100. The item selection module 47 is made active when the user chooses icon 15 from the Menu screen of the imaging phone 1. A start-up screen of the item selection module 47 is shown in FIG. 7(a).

In FIG. 7(a), a text of “Presentation Creator”, which is the name of the multimedia presentation-creating software 39, is displayed at position 51 in the LCD screen 2. The letters of “Menu” are displayed at the lower left 52 in the screen, which shows that the user can access the menu of the item selection module 47 by pressing the left key 4. Also, the letters of “Exit” are displayed at the lower right 53 of the screen, which shows that the user can terminate the operation of the item selection module 47 by pressing the right key 3.

Referring to FIG. 6, and moving to step S110. This step is to choose ways of deciding the items. When the user pushes the left key 4 from the screen shown in FIG. 7(a), the menu 54 emerges from under the screen, and the view of the LCD screen 2 changes as shown in FIG. 7(b). The menu 54 comprises menu options of “Auto” 56, “Set Period” 57, “Manual” 58, and “Setting” 59. The user can choose either of these options by manipulating the function key 3. If “Auto” 56 is chosen, the item selection module 47 enters a mode for searching the access history to find automatically data files accessed in a default period, and for deciding retrieved files as files to be used for the multimedia presentation (step S130-S140). If “Set Period” 57 is selected, the selection module 47 enters a mode for searching the access history to find data files accessed in a user-designated period and for selecting retrieved files for the multimedia presentation (step S150-S170). If “Manual” 58 is selected, the selection module 47 enters a mode in which the user can select manually the items recorded in the access history for the multimedia presentation. “Setting” 59 is a menu option to set the default period used in “Auto” 56.

If the user select “Auto” 56, the item selection module 47 automatically searches the access history created by the event record module 46 (step S140 of FIG. 6), and selects the files accessed in the default period as the files used to create a multimedia presentation (step S150). When the selection is completed, the item selection module 47 stops operation (step S200), and after that the presentation-creating module 48 starts creation of a new multimedia presentation by using the selected files (step S30 in FIG. 5).

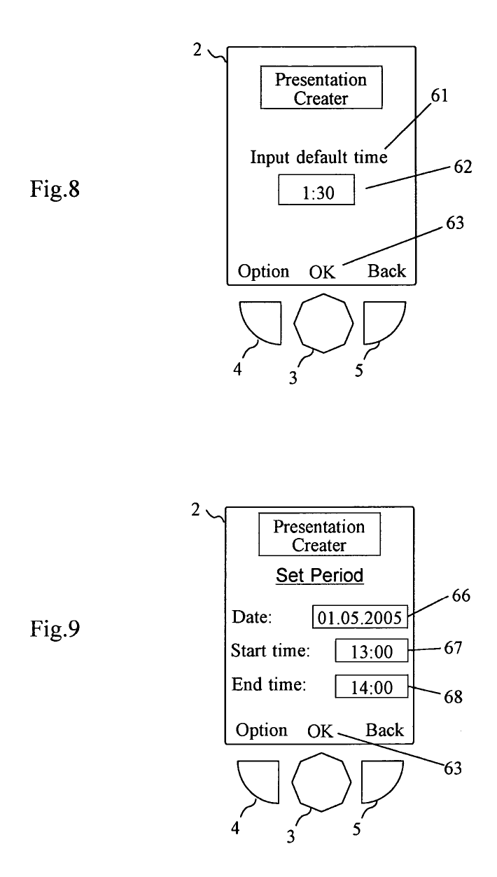

The default period may be set as, for example, a period from now to a certain time ago, or a period from now to the time when the image viewer 20 or the video player 21 last time. By selecting “Setting” 59 in the status of FIG. 7(b), the user can move to a user interface to change the default period. FIG. 8 is the screen view for changing the default period. The letters of “Input default time” are displayed at the center 61 of the LCD screen 2, and under of those a box 62 is provided to input a time. When the user inputs a preferred time in the box 62 using the ten-key 6, said default period is set as a period from now to the input time ago. In FIG. 8, since 1:30 is inputted in the box 62, the default period is set as a period from now to 1 hour and 30 minutes ago. In FIG. 8, the letters of “OK” are displayed in the center lower part 63 of the screen. It shows that the setting mode 59 will be terminated if the function key 3 is pressed.

If the user selects “Set Period” 57 from the status of FIG. 7(b), the view of the LCD screen 2 changes as shown in FIG. 9 (Step S150 of FIG. 6). FIG. 9 is a user interface to specify the period of the selection module 47 searching items to be used for the multimedia presentation. In the screen shown in FIG. 9, the Date entry box 66, the Start-time entry box 67, and the End-time entry box 68 are provided in the LCD screen 2. When the user inputs desired date and time in these boxes, the item selection module 47 searches files accessed in the period specified by those date and time, and selects the retrieved files as the files to be used for the multimedia presentation. In FIG. 9, since “01.05.2005” is inputted in the Date entry box 66, “13:00” is inputted in the Start-time entry box 67, and “14:00” is inputted in the End-time entry box 68, the specified period is 13:00-14:00 of May 1, 2005.

In FIG. 9, the letters “OK” are displayed in the center lower part 63 of the screen. After inputting desired date and time in the boxes 66-68, if the user presses the function key 3, the designated period is fixed and the item selection module 47 starts searching the access history in the designated period (step S160 of FIG. 6.) Then the item selection module 47 decides the retrieved files as the files to be used for the multimedia presentation (step S170), and then stops operation (step S200). After that the presentation-creating module 48 creates a new multimedia-presentation file by using the decided files (step S30 in FIG. 5).

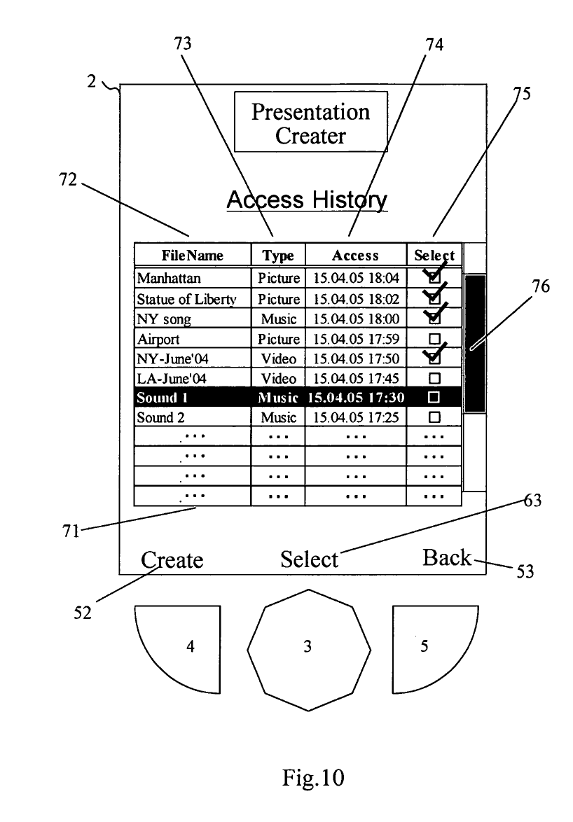

When the user selects “Manual” 58 from the status of FIG. 7(b), the aspect of LCD screen 2 changes as shown in FIG. 10 (step S180 of FIG. 6). FIG. 10 illustrates a user interface of the item selection module 47 which is used by the user to choose manually the items recorded in the access history for the multimedia presentation to be created. The aspect of the access history 71, created by the event record module 46, is displayed at the center of LCD screen 2. In the access history 71 the names of the files accessed are presented in the first row 72, the types of files (i.e., picture, video, music, text . . . ) are presented in the second row 73, and accessed times are presented in the third row 74. The forth row 75 contains check boxes used for selecting presented files. In case that the whole of the access history can not be displayed in the screen at once, the user can browse the other part of the access history using the scroll bar 76.

The user can blackout any of columns of the access history 71 by manipulating the function key 3. FIG. 10 illustrates that the column containing a music file “Sound 1” is made blackout. If the function key 3 is pressed while a column being blackoutted, a check mark is added to the checkbox 75 of the blackoutted column and the file presented in the column is selected for the multimedia presentation to be created (step S190 of FIG. 6). In FIG. 10, it is shown that the selected files are picture files of “Manhattan” and “Statue of Liberty”, a video file of “NY—June '04”, and a music file of “NY song”. If the user presses the left key 4 after selecting all the desired files, then the item selection is completed. The item selection module stops its operation (step S200), and then the presentation-creating module 48 creates a new multimedia-presentation file by using the selected files (step S30 in FIG. 5).

The created multimedia presentation is a video clip and can be replayed with the video player 21. When it is replayed, each of the picture “Manhattan” and “Statue of Liberty” are presented in 1 second respectively at the beginning, then the video “NY—June '04” is replayed. The music “NY song” is used as background music of this video clip. The length of the video clip is edited to 10 second so as to suit sending by MMS. The resolution of the video clip is also adjusted to be suit for MMS.

It should be noted that the created multimedia presentation will also be recorded in the access history. Therefore, by applying the above software 39 to the created presentation file, it is possible to create a still further new presentation file by adding additional video clips or sounds. And preferably the imaging phone 1 is arranged to enable the user to edit the created multimedia presentation later. In this case, preferably it is arranged to enable for the user to utilize the access history so that the user can add the items recorded in the access history.

In this way, according to the imaging phone 1, the user can select very easily the multimedia contents to be used as the elements of the multimedia presentation based on the access history. Therefore, there is provided a way for creating the multimedia presentation easily. Also, by equipping existing portable electronic devices with the multimedia presentation creating software 39, it is possible to add above-explained features on the portable electronic devices, which can increase the usability and market values of the portable electronic devices.

The present invention has been described above by using a preferred embodiment. It should be understood that the embodiment of the present invention can take a lot of variations; the various modification may be possible within the scope of the present invention. The present invention may be applied not only for creating presentation files containing multimedia contents as the described embodiment, but also for creating different kind of data files. Also the present invention may be applied not only to mobile phones but also to any portable electronic devices such as PDAs, notebook computers, digital cameras, music players, portable DVD players, or voice recorders.

1. A portable electronic device creating a new data file being arranged:
to record an event history associated with an item accessed by the portable electronic device;
to select an item for the new data file by utilizing the event history; and
to create the new data file from the decided item.

2. A portable electronic device according to claim 1, wherein said items being any of a text data file, an audio data file, a still-image data file, or a movie data file.

3. A portable electronic device according to claim 1, wherein said new data file comprising at least one of a text data, an audio data, a still-image data, and a movie data.

4. A portable electronic device according to claim 1, wherein said event history recording, in relation to an occurrence of an event, an identity information of said item associated with the event and/or a time of the event occurred; the event containing at least one of an opening, an editing, and a transmitting of the item.

5. A portable electronic device according to claim 1 being adapted to select the item accessed in a predetermined period for said new data file.

6. A portable electronic device according to claim 5 providing means for changing said predetermined period.

7. A portable electronic device according to claim 1 being arranged to enable editing the created new data file by utilizing said event history.

8. A portable electronic device creating a new data file being arranged:
to record an event history associated with an item accessed by the portable electronic device;
to present the item recorded in the event history for a user to select the recorded item for the new data file; and
to create the new data file from the item selected by the user.

9. A computer program for creating a new data file in a portable electronic device, wherein the computer program instructing the portable electronic device to work as:
means for recording an event history associated with an item accessed by the portable electronic device;
means for a decision of an item for the new data file by utilizing the event history; and
means for creating the new data file from the decided item.

10. A computer program according to claim 9, wherein said items being any of a text data file, an audio data file, a still-image data file, or a movie data file.

11. A computer program according to claim 9, wherein said new data file comprising at least one of a text data, an audio data, a still-image data, and a movie data.

12. A computer program according to claim 9, wherein said event history recording, in relation to an occurrence of an event, an identity information of said item associated with the event and/or a time of the event occurred; the event containing at least one of an opening, an editing, and a transmitting of the item.

13. A computer program according to claim 9, wherein said decision means being adapted to select the item accessed in a predetermined period for said new data file.

14. A computer program according to claim 13 providing means for changing said predetermined period.

15. A computer program according to claim 9, wherein
the decision means presenting the item recorded in the event history to a user for the user's selection,
the creating means creating the new data file from the item selected by the user.

16. A portable electronic device comprising a computer program according to claim 9.

17. A method for creating a new data file in a portable electronic device comprising:
a step for recording an event history associated with an item accessed by the portable electronic device;
a step for selecting an item for the new data file by utilizing the event history; and
a step for creating the new data file from the decided item.

18. A method for creating a new data file in a portable electronic device comprising:
a step for recording an event history associated with an item accessed by the portable electronic device;
a step for presenting the item recorded in the event history for a user to select the recorded item for the new data file; and
a step for creating the new data file from the item selected by the user.
